(19) United States
(12) Patent Application Publication
(10) Pub. No.: US 2005/0134064 A1
(43) Pub. Date: Jun. 23, 2005

(54) Pivoting tool

(76) Inventor: Juergen Nies, Winchester, VA (US)

Correspondence Address: AKERMAN SENTERFITT, P.O. BOX 3188, WEST PALM BEACH, FL, 33402-3188, US

(21) Appl. No.: 10/740,233

(22) Filed: Dec. 18, 2003

(51) Int. Cl. A01B 1/20; B25G 3/38

(52) U.S. Cl. 294/51; 294/53.5

(57) ABSTRACT

Embodiments of the invention relate to a tool having a working head that is pivotally adjustable relative to an elongated shaft. The working head of the tool can be almost any type of tool including gardening tools (hoes, rakes, shovels, etc.) and cleaning tools (mops, brooms, squeegies, etc.). Embodiments of the invention can include an elongated shaft and a pivot arm, which is pivotally connected to one end of the shaft. Embodiments of the invention provide apparatus for allowing a user to pivotally adjust the angular orientation of the pivot arm relative to the elongated shaft, and also for substantially locking the pivot arm in place once the desired orientation is achieved. The pivoting tool according to the invention can pivot about 90 degrees in either direction from a central location in which the pivot arm is substantially aligned with the shaft.

### CROSS-REFERENCE TO RELATED APPLICATIONS

(Not Applicable)

### STATEMENT REGARDING FEDERALLY SPONSORED RESEARCH OR DEVELOPMENT

(Not Applicable)

### FIELD OF THE INVENTION

The invention relates in general to tools and, more particularly, to tools having adjustable working heads.

### BACKGROUND OF THE INVENTION

In the context of gardening, there are numerous tools that can be used for working the ground and other purposes. For instance, a garden hoe can be used for digging, loosening soil, cultivating and weeding. A hoe generally has an elongated handle with a thin flat blade fixed at one end of the handle. However, the fixed connection between the handle and blade can, in some situations, result in difficulties for a person using the hoe.

For instance, there may be certain areas of a yard that a gardener may wish to avoid or may have trouble accessing, such as in and around flowerbeds, bushes or shrubs. A gardener may have to position himself in inconvenient positions or in undesired locations in order to properly use the hoe. For example, a gardener may have to step into the flowerbeds or to push himself into bushes, which may not only harm the plants but may also cause discomfort to the gardener himself. Further, a gardener may avoid such tight areas and try to manipulate the hoe in a manner other than in its intended orientation, which, in turn, can reduce the efficiency of the hoe and introduce muscle pain to the gardener.

Such problems are not unique to gardening or gardening tools, and can arise in a number of applications in which a tool includes a rigid connection between the handle and the tool head. For instance, in a household setting, large appliances or immovable fixtures may pose obstructions to a person using a broom to sweep a floor or to a person using a mop to wash a floor. Thus, there is a need for a tool that can allow a user to quickly adjust the orientation of a tool head so that such difficult areas can be more easily reached and the tool can be used in its intended manner.

### SUMMARY OF THE INVENTION

Aspects of the present invention relate to pivoting tools. In a first embodiment, a pivoting tool can include an elongated shaft, a pivot arm, and a lock pin. The shaft has a proximal end, a distal end, and a longitudinal axis defined therebetween. The pivot arm has a first end including a plurality of notches therein and a second end adapted for connection to a tool head. The pivot arm is pivotally connected at its first end to the distal end of the shaft.

The lock pin is movably connected to the distal end of the shaft and is movable between a first position and a second position. In the first position, the lock pin substantially lockingly engages one of the plurality of notches in the first end of the pivot arm. Thus, the pivot arm is prevented from pivoting relative to the longitudinal axis of the shaft. In the second position, the lock pin is substantially disengaged from the plurality of notches in the pivot arm. As a result, a user can pivotally adjust the orientation of the pivot arm relative to the longitudinal axis of the shaft.

The lock pin can be biased toward the first position such as by a spring. The lock pin can disposed at least partially within the distal end of the handle. The lock pin can move substantially along the longitudinal axis of the shaft. A trigger can extend from the lock pin; thus, a user can engage the trigger with a finger to move the lock pin between the first and second positions.

The pivot arm can have a range of pivoting motion of about 90 degrees on each side of the longitudinal axis of the shaft. One of the plurality of notches can positioned on the pivot arm such that, when the lock pin substantially lockingly engages this notch, the pivot arm can be substantially in line with the shaft. One of the plurality of notches can be positioned on the pivot arm such that, when this notch is substantially lockingly engaged by the lock pin, the pivot arm can be disposed at one of about 90 degrees, about 60 degrees, about 45 degrees, or about 30 degrees relative to the shaft.

In a second embodiment, a pivoting tool includes an elongated shaft, a pivot arm, a handle movably mounted to the shaft, and a pair of connecting rods. The elongated shaft has a proximal end and a distal end and a longitudinal axis extending therebetween. The pivot arm has a first end and a second end. The second end of the pivot arm is adapted for connection to a tool head; the first end of the pivot arm is pivotally connected to the distal end of the shaft. Each connecting rod has a proximal end and a distal end where the proximal ends of the connecting rods are operatively associated with the handle and the distal ends of the connecting rods are operatively associated with the pivot arm. The connecting rods can be substantially parallel to the longitudinal axis of the shaft. This arrangement allows the connecting rods to transmit the movement of the handle to the pivot arm such that the pivot arm pivots in substantially the same direction as the movement of the handle.

The pivoting tool can further include a lock for substantially maintaining the pivot arm in place relative to the shaft. To that end, the handle can includes a raised wall along a portion of the handle, and the raised wall can include a plurality of notches. In addition, the lock can be a strip of spring steel that substantially lockingly engages one of the plurality of notches in the raised wall. One of the plurality of notches can be positioned on the raised wall such that, when this notch is substantially lockingly engaged by the strip of steel, the pivot arm can disposed at one of about 90 degrees, about 60 degrees, about 45 degrees, or about 30 degrees, or substantially in line with respect to the longitudinal axis of the shaft.

Either of the above embodiments of a pivoting tool can further include a tool head secured to the first end of the pivot arm. The tool head can be a gardening tool such as, for example, a shovel; a garden rake; a hoe; a fork; a trowel; a cultivator; combination tools; a patio weeder; a weeder; an edger; an edging knife; a yard rake; a grubber; a tiller; and a plow, to name a few. Alternatively, the tool head can be one of scrub brushes, brooms, mops, and squeegees.

### BRIEF DESCRIPTION OF THE DRAWINGS

FIG. 1 is an isometric view of a first embodiment of a pivoting tool according to aspects of the present invention.

FIG. 2 is an exploded isometric view of the first embodiment of a pivoting tool according to aspects of the present invention.

FIG. 3A is a cross-sectional view of the first embodiment of a pivoting tool according to aspects of the present invention showing a lock pin in a first position, thereby substantially preventing the pivot arm from moving.

FIG. 3B is a cross-sectional view of the first embodiment of a pivoting tool according to aspects of the present invention showing a lock pin in a second position, thereby allowing the pivot arm to be moved.

FIG. 4 is a plan view of the first embodiment of a pivoting tool according to aspects of the present invention.

FIG. 5 is an isometric view of various possible tool heads that can be used in accordance with embodiments of the present invention.

FIG. 6 is an isometric view of a second embodiment of a pivoting tool according to aspects of the present invention.

FIG. 7 is an exploded isometric view of the second embodiment of a pivoting tool according to aspects of the present invention.

FIG. 8 is a plan view of the second embodiment of a pivoting tool according to aspects of the present invention.

### DETAILED DESCRIPTION OF EMBODIMENTS OF THE INVENTION

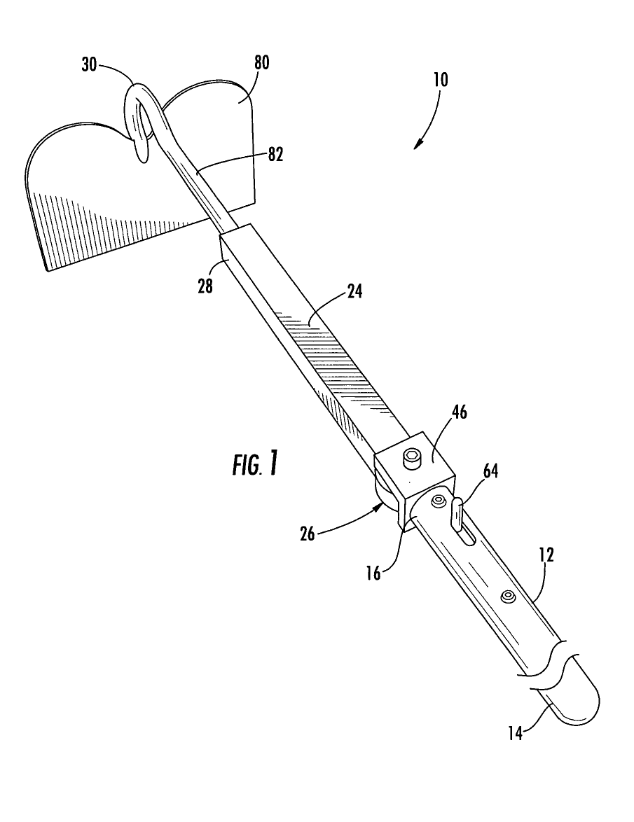

Aspects of the present invention address the drawbacks associated with prior tools having a fixed connection between the handle and the working head. Embodiments of the present invention relate to a tool assembly with a pivotally adjustable working head. Embodiments of the invention are shown in FIGS. 1-8, but the present invention is not limited to the illustrated structure or application. Further, the following detailed description is intended only as exemplary.

One embodiment of a pivoting tool apparatus 10 according to aspects of the invention is shown in FIGS. 1-4. The pivoting tool 10 can include a number of individual components. Each component of the assembly will be discussed in turn below.

One component of the pivoting tool 10 is an elongated shaft 12. The shaft 12 can have a proximal end 14 and a distal end 16. Use of the terms “proximal” and “distal” herein is meant to indicate the relative position of each end of the shaft 12 with respect to a user. Such terms are used for convenience to facilitate discussion and are not intended to limit the scope of the invention. The shaft 12 can have a longitudinal axis 18 defined between its proximal and distal ends 14,16.

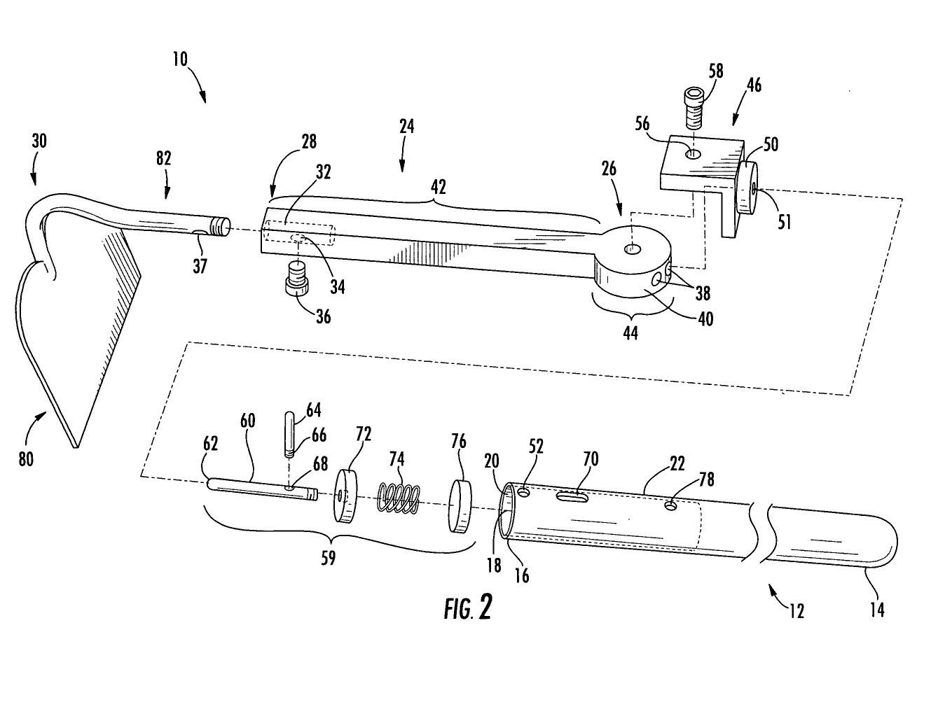

The shaft 12 can be made of almost any material including wood, fiberglass, metal, composites, and plastic, to name a few. Likewise, the shaft 12 can have almost any shape or cross-sectional geometry, and embodiments of the invention are not limited to any particular shape or cross-sectional geometry for the shaft 12. As shown in FIG. 2, the shaft 12 can be generally cylindrical, but, again, other conformations are possible. Preferably, the shaft 12 is shaped for the comfort of the user. To that end, the shaft 12 can have any of a number of associated ergonomic contours or features. The shaft 12 can be substantially straight, but it can also be curved or bent. Correspondingly, the longitudinal axis 18 of the shaft 12 can be straight or include one or more curves or bends.

The shaft 12 can be substantially solid or it can include one or more hollow portions. In one embodiment, the shaft 12 can include a hollow portion 20 that begins at the distal end 16 and extends toward the proximal end 14. As will be explained later, the hollow portion 20 can house other components of the pivoting tool assembly 10. The hollow portion 20 can be sized and shaped as necessary to accommodate these other components. In addition, the shaft 12 may have one or more openings 52,70,78, extending from the outer peripheral surface 22 of the shaft 12 to the hollow portion 20; these openings can be provided as needed for purposes of, among other things, mounting, user access, and/or to accommodate other components of the pivoting tool assembly 10. The shaft 12 can be almost any length and, preferably, the shaft 12 is sufficiently long such that a user has enough room to grip the shaft 12 with two hands without substantial obstruction or interference from other components of the tool assembly 10 according to aspects of the invention.

Another component of the pivoting tool assembly 10 is a pivot arm 24. The pivot arm 24 can have a first end 26 and a second end 28. The second end 28 of the pivot arm 24 can be adapted for connection to a tool head 30. In one embodiment, the second end 28 can include an opening 32 for receiving a portion of the tool head 30. The opening 32 can begin at the second end 28 and extend toward the first end 26 of the pivot arm 24. The tool head 30 can be secured in the opening 32 in various ways including threaded engagement, fasteners, adhesives, welding, or interference fit, to name a few. In one embodiment, the connection can be made by providing a hole 34 in the pivot arm 24 that is substantially transverse to the opening 32. In such case, a fastener, such as a set screw 36, can be inserted in the hole 34 and into engagement with a portion of the tool head 30 disposed inside of the opening 32 in the pivot arm 24 so as to secure the tool head 30 to the pivot arm 24. The tool head 30 can provide a recess, dimple, notch or indent 37 for receiving the fastener. There are still other manners of connecting the tool head 30 to the pivot arm 24, and the pivot arm 24 need not provide the opening 32 as the tool head 30 can be connected to the exterior of the pivot arm 24 by, for example, fasteners, adhesives, or welding. Alternatively, the pivot arm 24 and the tool head 30 can be a single piece. However, it is preferred if the tool head 30 is connected to the pivot arm 24 so as to be removable. Thus, other tool heads can be connected to the pivot arm 24 as needed depending on the task at hand.

The first end 26 of the pivot arm 24 can include a plurality of notches 38. Each of the notches 38 can be substantially identical to each other and can be substantially aligned along the first end 26 of the pivot arm 24. The plurality of notches 38 can be disposed on at least one peripheral surface of the pivot arm 24. For instance, the notches 38 can all be on one continuous peripheral surface, such as the arcuate surface 40 shown in FIG. 2. Alternatively, the notches 38 can be disposed over multiple peripheral surfaces (not shown) on the first end 26 of the pivot arm 24, such as if the first end 26 is generally polygonal in shape. There can be any quantity of notches 38, but, preferably, there are at least three notches 38, as will be described later. The notches 38 can be any cross-sectional geometry and conformation, but, preferably, the notches 38 are sized and shaped to matingly engage other components of the pivoting tool assembly 10 as will be described later. Further, the notches 38 can extend into the pivot arm 24 at various depths.

The pivot arm 24 can be made from any material and it is not necessarily made from the same material as the shaft 12. Further, the pivot arm 24 can have any of a number of configurations. For instance, as shown in FIG. 2, the pivot arm 24 can include a forward section 42 and a rearward section 44. The forward section 42 can be elongated. Further, the forward section 42 can be generally rectangular, but other conformations are possible including circular, polygonal and triangular. The forward section 42 includes the second end 28. The rearward section 44, as shown in FIG. 2, can be generally cylindrical; in such case, the first end 26 includes a substantially arcuate outer peripheral surface 40. However, aspects of the invention are not limited to any particular conformation for the rearward section 44.

The first end 26 of the pivot arm 24 can be pivotally connected, directly or indirectly, to the distal end 16 of the shaft 12. In other words, the pivot arm 24 can be directly attached to the distal end 16 of the shaft 12 such that the pivot arm 24 can pivot relative to at least the distal end 16 of the shaft 12 or relative to the longitudinal axis 18 of the shaft 12 at least at the distal end 16 of the shaft 12. One manner of achieving a pivoting relation between a directly connected pivot arm 24 and shaft 12 is by way of a shoulder screw. There are still other ways of achieving a pivoting relation as would be appreciated by one skilled in the art. Alternatively, the pivot arm 24 can be pivotally attached to one or more components interposed between the pivot arm 24 and the shaft 12. One example of an indirect connection is shown in FIG. 2 in which a bracket 46 can be disposed between the pivot arm 24 and the shaft 12. The bracket 46 can be fixedly secured to the shaft 12, and the pivot arm 24 can be pivotally connected to the bracket 46 by way of, for example, a shoulder screw.

The bracket 46 can have any of a number of configurations and, in one embodiment, as shown in FIG. 2, the bracket 46 can be generally L-shaped. In such case, a protrusion 50 can extend from the bracket 46. The protrusion 50 can interface with the shaft 12 in a number of ways. In one embodiment, the protrusion 50 can be received within the hollow portion 20 of the distal end 16 of the shaft 12. In addition, an opening 52 can be provided in the shaft 12 in which a fastener, such as a set screw 54, can be inserted to securely engage the protrusion 50 of the bracket 46. Alternatively, the protrusion 50 can be secured inside of or over the distal end 16 of the shaft 12 by adhesives, welding, interference fit or threaded engagement, to name a few possibilities. The bracket 46 can provide an opening 56 for receiving a fastener, such as a shoulder screw 58, that can be used to pivotally connect the pivot arm 24 to the bracket 46 and shaft 12.

A pivoting tool according to embodiments of the invention also includes a system for selectively retaining the pivot arm 24 in fixed relation to the shaft 12. One possible system 59, shown in FIG. 2, can include a lock pin 60. The lock pin 60 can be movable between a first position and a second position.

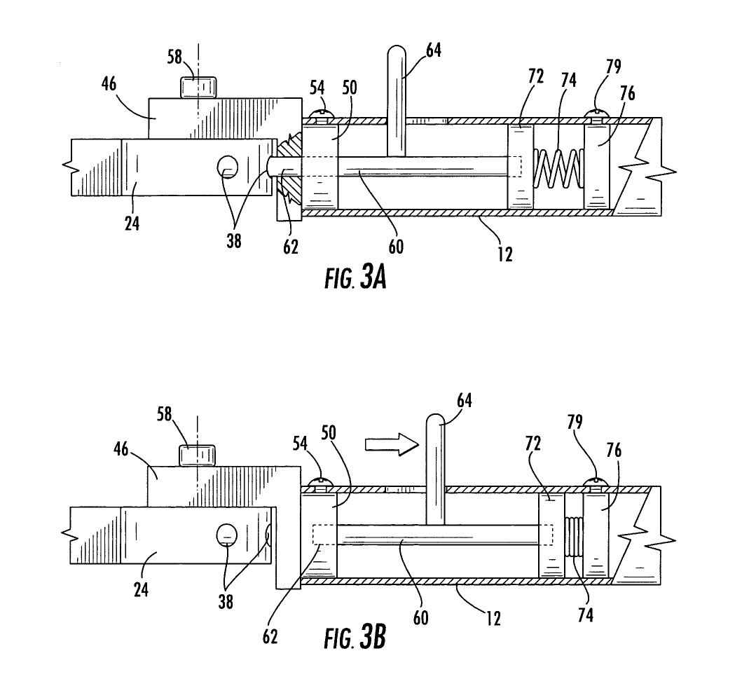

In the first position, shown in FIG. 3A, at least a portion of the lock pin 60, such as the tip 62, can substantially lockingly engage one of the plurality of notches 38 in the pivot arm 24. As a result, the pivot arm 24 is substantially prevented from pivoting relative to the shaft 12 or the longitudinal axis 18 of the shaft 12. In some cases, the lock pin 60 can be biased toward the first position. In one embodiment, the lock pin 60 can be disposed at least partially within the distal end 16 of the shaft 12. In such case, the lock pin 60 can be biased axially outward from the distal end 16 of the shaft 12 and, in one embodiment, substantially along the longitudinal axis 18 of the shaft 12. Still other directions of bias are possible. Further, where an L-shaped bracket is used as shown in FIG. 2, the lock pin 60 can pass through an opening 51 provided in the L-shaped bracket. In other embodiments, the lock pin 60 may be disposed outside of the shaft 12. Embodiments of the invention are not limited to any specific location for the lock pin 60, or to any specific direction of bias for the lock pin 60.

In the second position, shown in FIG. 3B, the lock pin 60 can be substantially disengaged from the plurality of notches 38 in the pivot arm 24. As a result, the pivot arm 24 is free to pivot relative to the shaft 12 or to the longitudinal axis 18 of the shaft 12. Thus, a user can pivotally adjust the orientation of the pivot arm 24 relative to the shaft 12 or to the longitudinal axis 18 of the shaft 12.

The lock pin 60 an be almost any shape, and its cross-sectional geometry, at least at its tip 62, can be shaped to matingly lockingly engage any one of the plurality of notches 38 in the pivot arm. Further, the tip 62 of the pin 60 can include one or more features, such as a chamfer, to facilitate engagement with the notches 38. The lock pin 60 can be made of any of a number of materials, such as metal, plastic, or wood, to name a few. In one embodiment, the lock pin 60 can be substantially cylindrical in conformation. The lock pin 60 can be substantially straight or it can include one or more bends or curves.

The lock pin 60 can further provide a trigger 64 for facilitating user manipulation of the lock pin 60. The user trigger 64 can be connected to the lock pin 60 in various manners. For example, as shown in FIG. 2, the trigger 64 can include threads 66 at one end so as to threadbly engage a threaded opening 68 provided in the lock pin 60. Securement by threaded engagement is preferable when the lock pin 60 is disposed at least partially in the distal end 16 of the shaft 12, as such engagement can facilitate installation. For instance, the lock pin 60 can be inserted into the distal end 16 of the shaft 12. Then, the trigger 64 can be inserted through an opening or cutout 70 in the shaft 12, and brought into engagement with the lock pin 60. Once joined, a portion of the trigger 64 can extend through the opening 70 provided in the shaft 12, allowing a user to engage the trigger 64 with a finger.

The trigger 64 and lock pin 60 can be secured by more permanently such as by welding or brazing. In one embodiment, the trigger 64 can extend substantially perpendicularly from the lock pin 60. Preferably, the lock pin 60 and/or trigger 64 are positioned along the shaft 12 such that they are within the reach of a user. The trigger 64 can be made of any material including metals and plastics, to name a few. In one embodiment, the trigger 64 and the lock pin 60 can be made of substantially the same material.

The lock pin 60 can further include a base 72. The base 72 can be secured to one end of the lock pin 60 in various manners. For instance, the lock pin 60 can be welded to the base 72 or it can be secured by threaded engagement. Alternatively, the lock pin 60 and base 72 may be a single part. The base 72 can provide a surface against which a biasing element, such as a spring 74, can force the lock pin 60 toward the first position or otherwise into engagement with one of the plurality of notches 38 in the pivot arm 24. The amount of the biasing force can vary, but, preferably, a user can overcome the force with a single finger. In the embodiment shown in FIG. 2, the spring 74 can bias the lock pin 60 axially outward from the distal end 16 of the shaft 12. Other directions of bias are possible, depending on the configuration of the lock pin 60, shaft 12, pivot arm 24, and/or notches 38.

The biasing element can act between the base 72 and another surface. To that end, a spacer 76 can be provided in the hollow portion 20 of the shaft 12. The spacer 76 can be retained in place by adhesive, welding, interference fit or by one or more fasteners, such as a set screw 79 inserted through an opening 78 in the shaft 12. The spacer 76 can be made of almost any material such as metals, plastics, wood or composites, to name a few. Some embodiments may not include a spacer at all; instead, the biasing element can act between the base 72 of the lock pin 60 and, for instance, a back wall of the hollow interior 20 of the shaft 12.

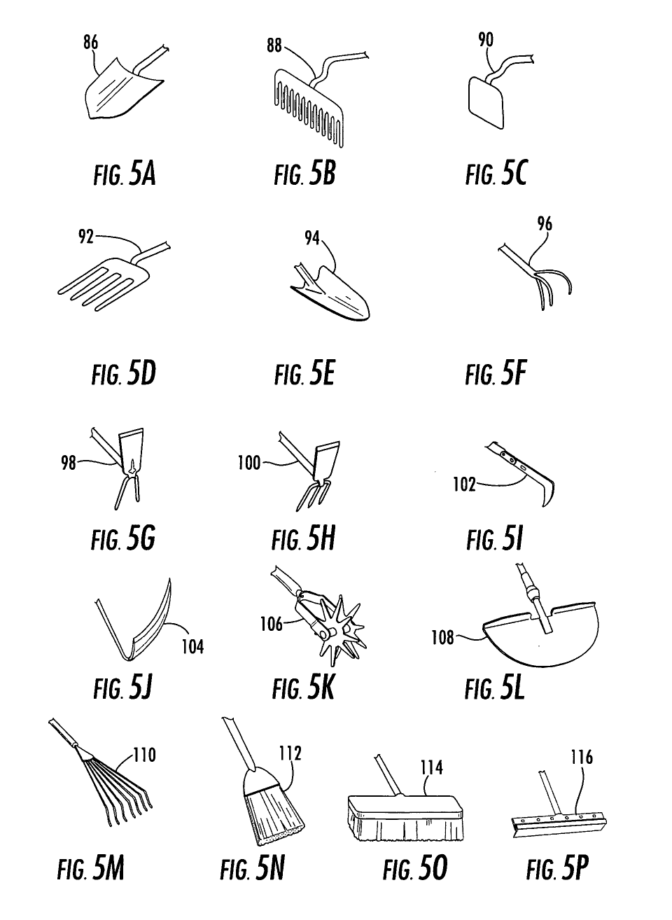

The assembly 10 can further include a tool head 30, which can be any of sundry tools. The tool head 30 can generally comprise a working portion 80 and a connection portion 82. The working portion 80 of the tool head 30 can have any of a variety of configurations. For example, referring to FIG. 5, the working portion 80 of the tool head 30 can be any gardening tool including, but not limited to: a shovel 86; a garden rake 88; a hoe 90; a fork 92; a trowel 94; a cultivator 96; combination tools 98,100; a patio weeder 102; a weeder 104; an edger 106; an edging knife 108; a yard rake 110; a grubber (not shown); a tiller (not shown); and a plow (not shown). However, the tool head 30 used in connection with the pivoting tool assembly 10 of the invention is not limited to garden tools. Rather, other tools can be used in connection with embodiments of the invention including, but not limited to: a broom 112; a scrub brush 114; or a squeegie 116. Embodiments of the invention are not limited to any particular type of tool head 30 or working portion 80 of the tool head 30.

The connection portion 82 of the tool head 30 can be substantially straight or it can include one or more bends. Further, the connection portion 82 of the tool head 30 can have any cross-sectional shape, such as round, polygonal or rectangular. The connection portion 82 of the tool head 30 can be secured to the pivot arm 24 in several ways. In one embodiment, the connection portion 82 of the tool head 30 can be inserted into the opening 32 in the second end 28 of the pivot arm 24. Accordingly, the connection portion 82 can be sized and shaped to be received in the opening 32 in the pivot arm 24. In such case, the connection portion 82 of the tool head 30 can include a recess, dimple, notch, indent, keyway or depression 37 for interfacing with a fastener, such as a set screw 36 extending through an opening 34 in the shaft 12 so as to retain the tool head 30 in place. Other ways of retaining the tool head 30 are possible as will be appreciated by those skilled in the art.

There are a variety of ways in which a pivoting tool 10 according to the above-described embodiments of the invention can be used. One example of a manner in which the above-described pivoting tool 10 can be used will now be described in the context of a pivoting tool with a garden hoe 90 for a tool head 30. At the outset, the user may wish to use the hoe in the conventional manner; thus, the tool head 30 and pivot arm 24 can be substantially aligned with the shaft 12. In such case, the lock pin 60 is in the first position, shown in FIG. 3A, engaging one of the notches 38 in the pivot arm 24. The user can use the hoe in a conventional manner by pulling the shaft 12 toward the user such that the hoe working head 90 scratches the ground.

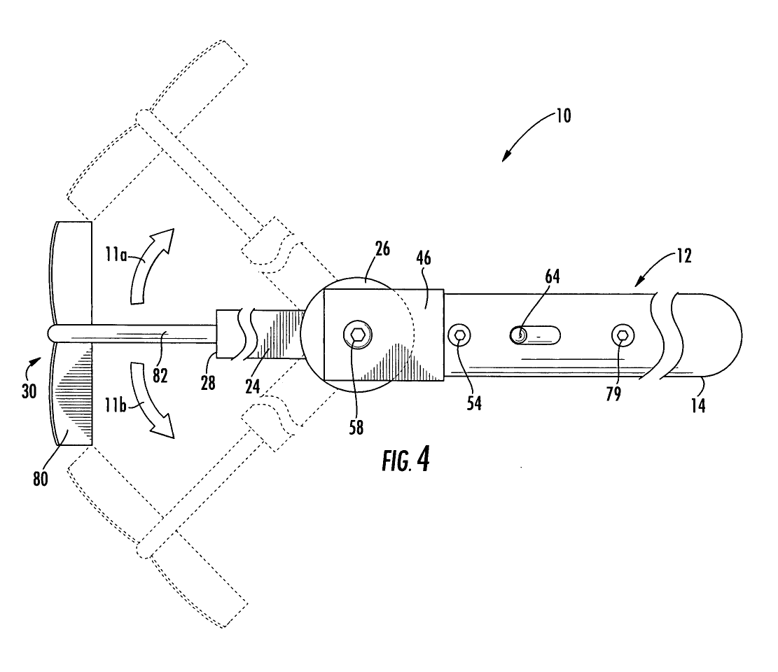

When the user encounters an area that is difficult to access, the orientation of the tool head 30 and pivot arm 24 can be altered relative to the shaft 12. For example, as shown in FIG. 4, the tool head 30 and the pivot arm 24 can pivot clockwise 11a or counterclockwise 11b relative to the shaft 12. In such case, the user can pull the trigger 64 toward the proximal end 14 of the shaft 12 such that the lock pin 60 moves to the second position, shown in FIG. 3B, in which the lock pin 60 is substantially disengaged from the notches 38. In this case, the pivot arm 24 is free to pivot relative to the shaft 12 and its longitudinal axis 18. The user can effect the pivoting motion of the pivot arm 24 by tilting the assembly 10 to one side such that the pivot arm 24 swings in that direction under the influence of gravity. Other methods for effecting the pivoting of the pivot arm 24 will be appreciated by one skilled in the art. Once in the desired position, the user can release the trigger 64 such that the lock pin 60 moves into the first position, under the influence of the spring 74, so that the lock pin 60 engages one of the plurality of notches 38. As noted earlier, the lock pin 60 and/or the notch 38 can include one or more features, such as a chamfer, to facilitate engagement. Then, the user can use the hoe to reach those challenging areas or to perform the task at hand without undue strain.

It should be noted that a notch 38 may or may not be provided at that exact location desired and the user may have to move the pivot arm 24 to a position where the lock pin 60 can engage a notch 38. Any number of notches 38 can be provided, and the range of pivoting motion of the apparatus 10 will be determined by at least by the quantity and placement of the notches 38 on the pivot arm 24. In one embodiment, there can be at least three notches. One of the plurality of notches 38 can be positioned on the first end 26 of the pivot arm 24 such that, when the lock pin 60 engages this notch, the pivot arm 24 and the shaft 12 are substantially aligned, as shown in FIG. 1, which, to facilitate discussion, will be referred to as the central position or central notch.

Additional notches can be positioned such that, when the lock pin 60 engages either of these notches, the pivot arm 24 can be oriented at about 90 degrees relative to the shaft 12 or the longitudinal axis 18 of the shaft 12. Preferably, there are two of such notches positioned such that the pivot arm 24 can be substantially locked at about 90 degrees relative to the shaft 12 on either side of the central position, thereby permitting a range of about 180 degrees of lock positions. Alternatively or in addition, two notches can be provided at substantially 45 degrees in either direction of the central notch.

The amount and range of locked positions of the apparatus 10 need not be substantially equal on either side of the central position. For instance, the pivot arm 24 may be able to lock at a maximum of about 90 degrees in one direction and a maximum of about 45 degrees in the opposite direction with respect to the central position. The first end 26 of the pivot arm 24 can have even more notches positioned so as to orient the pivot arm 24 at about 30 and/or at about 60 degrees relative to the shaft 12 or the longitudinal axis 18 of the shaft 12.

Again, any quantity of notches 38 can be provided. Further, the notches can be spaced according to regular intervals, such as about every 10 degrees. Alternatively, the notches 38 may be provided at irregular intervals or according to no particular pattern. Moreover, there need not be an equal number of notches 38 on each side of the central notch or on either side of the longitudinal axis 18 of the shaft 12.

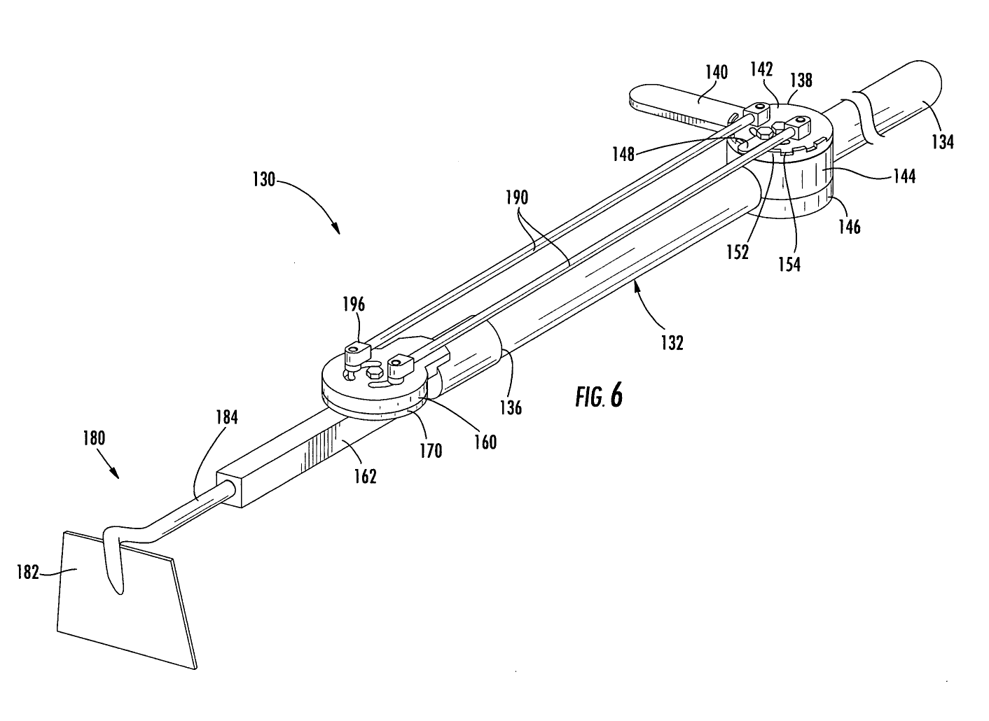

Another pivoting tool apparatus 130 according to embodiments of the invention is shown in FIGS. 6-8. The pivoting tool 130 can include a multitude of components, each of which will be discussed below.

The pivoting tool apparatus 130 can include an elongated shaft 132 having a proximal end 134, a distal end 136, and a longitudinal axis (not shown) extending therebetween. The previous discussion with respect to the shaft 12 is equally applicable to the shaft 132. The pivoting tool assembly 130 can further include a handle 138 that can be engaged by a user to cause a portion of the apparatus 130 to pivot.

The handle 138 can be a single or a multi-piece construction. Further, the handle 138 can be made of various materials including metal and plastic, just to name a few. The handle 138 can have any shape or conformation. In one embodiment, the handle 138 can include a actuator portion 140 and a mounting portion 142.

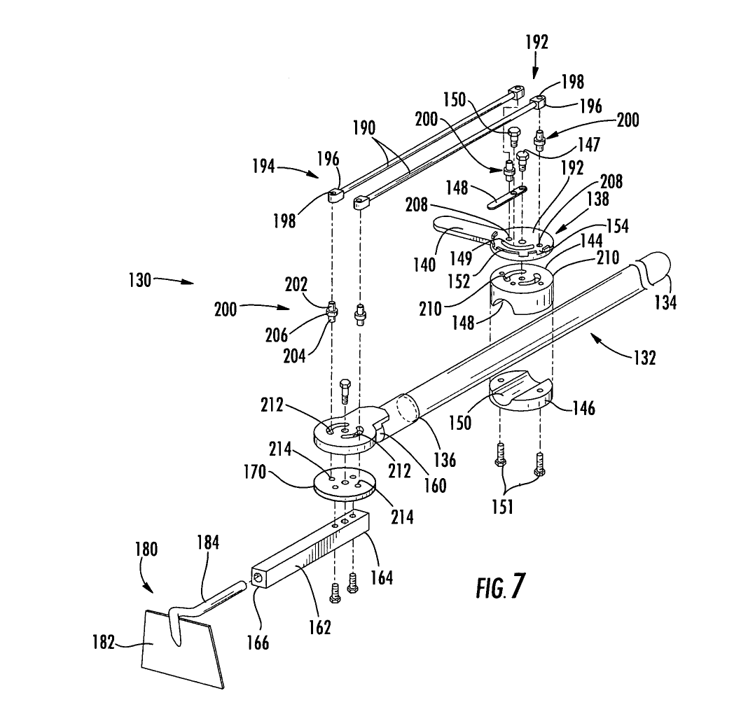

The handle 138 can be movably mounted to the shaft 132 in various manners. In one embodiment, the handle 138 can be pivotally mounted to the shaft 132. The handle 138 can be either directly or indirectly mounted to the shaft 132. Direct mounting can be accomplished by bolting the handle 138 to the shaft 132 using, for example, one or more fasteners such as a shoulder screw. An indirect mounting system is shown in FIG. 7, and it includes the use of upper and lower mounting blocks 144,146. It should be noted that the relative terms—“upper” and “lower”—are used to facilitate discussion and are not intended to limit the invention. While the upper and lower mounting blocks 144,146 can have almost any shape, it is preferred if the upper and lower mounting blocks 144,146 are shaped to substantially surround a portion of the shaft 132, such as by providing recesses or cutouts 148,150 in each of the mounting blocks 144,146. Further, the mounting blocks 144,146 can have corresponding or mating surfaces to facilitate engagement with each other. The upper and lower mounting blocks 144,146 can be secured together using one or more fasteners, such as bolts 151; the handle 138 can be movably mounted to the upper mounting block 144 by, for example, a shoulder bolt 147. The clamping force between the joined mounting blocks 144,146 can hold the blocks 144,146 on the shaft 132. Alternatively, one or more fasteners can be used to tie the mounting blocks 144,146 directly into the material of the shaft 132. Again, the use of the mounting blocks 144,146 is only one of many ways in which the handle 138 can be indirectly mounted to the shaft 132. Irrespective of the manner in which it is mounted to the shaft 132, the handle 138 is preferably positioned along the shaft 132 so that a user can readily access the handle 138, particularly the actuator portion 140.

The upper mounting block 144 can provide one or more features for mounting and/or interfacing with other components of the apparatus 130. For instance, the upper mounting block 144 can include a pair of grooves 210. The purposes for these features will be discussed later.

The pivoting tool assembly 130 can further include a lock system for maintaining the handle 138 in a desired position. In one embodiment, the lock system can include a substantially flat strip of spring steel 148 such as 16-gauge spring steel. The strip of steel 148 can be biased toward the substantially flat position. In such case, one end of the strip 148 can be secured to the handle 138. Preferably, the strip 148 does not move with the handle 138. In such case, the strip 148 can be secured to the upper mounting block 144 by a shoulder bolt 150, which passes through the handle 138. A channel 149 can be provided in the handle 138 so as to permit movement of the handle 138 despite the presence of the bolt 150. The channel 149 can have any of a number of conformations such as arcuate, as shown in FIG. 7. In addition or alternatively, the strip 148 can be secured by central shoulder bolt 147, which is used to connect the handle 138 to the upper mount 144. Preferably, the strip 148 is secured by both bolts 147,150 to thereby provide two mounting points so as to provide strength against the torque effect of the rotating handle. Other manners of attachment between the strip 148 and the handle 138, whether direct or indirect, are possible as would be appreciated by one skilled in the art.

The strip 148 can be of sufficient force to substantially lock the handle 138 in place, while allowing a user to overcome the spring force with a single finger. In one embodiment, the strip 148 can interact with portions or features of the handle 138 so as to substantially lock the handle 138 in place. For instance, the handle 138 can include a wall 152 along at least a portion of the edge or rim of the mounting portion 142, as shown in FIG. 7. The wall 152 can extend along a portion of the actuator portion 140 as well. The wall 152 can project substantially perpendicularly upward from the handle 138. The wall 152 can include one or more cutouts, breaks, interruptions, recesses, or notches 154. Alternatively, the wall 152 can comprise a plurality of walls with spaces between each of the plurality of walls.

Thus, when the strip 148, under its own bias, falls into one of the notches 154, the handle 138 is substantially restricted from moving relative to the shaft 132. To release the handle 138 so that is can be moved, a user must pull up on the strip 148 so as to defeat the spring force of the strip 148 and so that the strip 148 is disengaged from the notch 154. Then, a user can move the handle 138 as desired.

The distal end 136 of the shaft 132 can include an adapter 160. The adapter 160 can be part of the shaft 132. Alternatively, the adapter 160 can be a separate piece secured to the shaft 132 by, for example, threaded engagement, fasteners, adhesives, welding, brazing, and interference fit, to name a few possibilities. As shown in FIG. 7, the adapter 160 can fit over the distal end 136 of the shaft 132. In another embodiment, the distal end 136 of the shaft 132 can fit over at least a portion of the adapter 160. In the embodiment shown in FIG. 7, the adapter 160 includes a pair of slots or grooves 212. Aspects of the invention are not limited to any particular configuration for the adapter 160. The adapter 160 can be made of substantially the same material as the shaft 132 or it can be different. The adapter 160 can be made of metal such as aluminum or steel, plastic, wood, to name a few possibilities.

Another component of the pivoting tool assembly 130 is a pivot arm 162. The pivot arm 162 can be made of almost any material including metals such as aluminum or steel, plastic, wood, to name a few possibilities. Further, the pivot arm 162 can be, but is not necessarily made of the same material as the shaft 132 and/or adapter 160. Further, the pivot arm 162 can have any of a number of configurations. For instance, as shown in FIG. 7, the pivot arm 162 can be generally rectangular, as shown in FIG. 7, and still other conformations are possible including circular, polygonal and triangular, to name a few.

The pivot arm 162 can have a first end 164 and a second end 166. The second end 166 of the pivot arm 162 can be adapted for connection to a tool head 180; the previous discussion regarding some of the possible manners of attachment between the pivot arm 24 and the tool head 30 is equally applicable to the attachment between the tool head 180 and the pivot arm 162 in embodiments of the invention shown in FIGS. 6-8.

The first end 164 of the pivot arm 162 can be pivotally connected to the adapter 160. To that end, the adapter 160 can provide one or more surfaces and/or features for connecting to pivot arm 162. The connection between the adapter 160 and the pivot arm 162 can be direct or indirect. In other words, the pivot arm 162 can be directly attached to the adapter 160 in such a way that the pivot arm 162 can pivot relative to at least the distal end 136 of the shaft 132 or to the longitudinal axis (not shown) of the shaft 132. A pivoting relation can be achieved by way of a shoulder screw. Other ways of achieving a pivoting relation will be appreciated by one skilled in the art.

Alternatively, the pivot arm 162 can be pivotally attached to one or more components interposed between the pivot arm 162 and the shaft 132, for instance, a plate 170, as shown in FIG. 7. The plate can have any of a number of configurations, and, in one embodiment, the plate 170 can be a disk-shaped piece, as shown in FIG. 7. Additional details of this indirect mode of connection will be described later. In one embodiment, the plate 170 and the pivot arm 162 can be a single part, making the connection to the adapter 160 a direct one.

The assembly according to embodiments of the invention can further include one or more elongated connection rods 190. The connection rods 190 can transfer the motion of the handle 138 to the pivot arm 162 at the other end of the assembly 130. The connection rods 190 can have proximal and distal ends 192,194.

In one embodiment, there can be two connection rods 190. The connection rods 190 can be substantially parallel to each other and/or to the shaft 132 or the longitudinal axis of the shaft 132. The connection rods 190 can have various configurations. For instance, as shown in FIG. 7, the connection rods 190 can comprise substantially straight elongated rods. The proximal and distal ends 192,194 of the connection rods 190 can include one or more features for securing the connection rods 190 to other components of the apparatus 130. For instance, as shown in FIG. 7, each end of the connection rods 190 can include a block 196 having an opening 198. The blocks 196 can be used to engage other components of the assembly 130 as will be described below.

The connection rods 190 can be multi-part assemblies or they can be single part constructions. Further, the connection rods 190 can be substantially solid or they can include one or more hollow regions. In one embodiment, the connection rods 190 can be tight cables. The blocks 196 can be secured to the ends 192,194 of the connection rods 190 by threaded engagement, welding brazing, and adhesives, to name a few. Also, the connection rods 190 can be made of any of a number of materials including steel, aluminum, metals, alloys, plastic, composites, or combinations thereof.

There are several ways in which the connection rods 190 can interact with other components of the pivoting tool apparatus 130 according to the invention. For example, the proximal ends 192 of the connection rods 190 can be operatively connected to the handle 138; the distal ends 194 of the connection rods 190 can be operatively connected with the first end 164 of the pivot arm 162. One manner of achieving such operational association is by way of pins 200.

Each of the pins 200 can include an upper projection 202, a lower projection 204, and a middle section 206. The cross-sectional area of the middle section can be greater than the cross-sectional area of upper and lower projections 202,204. In one embodiment, each of the upper projection 202, the lower projection 204, and the middle section 206 are substantially cylindrical in conformation. In such case, the diameter of the middle section 206 can be greater than the diameter of the upper and lower projections 202,204. The lower projection 204 of the pin 200 can be substantially identical to the upper projection 202 of the pin 200. Further, lower projection 204 of the pin 200 can be substantially coaxial with at least the upper projection 202 of the pin 200.

The pins 200 can be made of various materials including metals, plastics, composites, to name a few. Further, the pins 200 can be assemblages of multiple parts joined by, for example, welding or brazing. Alternatively, the pins 200 can be a single piece made by, for example, casting or machining.

The pins 200 can be used in a variety of ways to operatively connect the connection rods 190 to the other components of the pivoting tool apparatus 130. For instance, in the embodiment shown in FIG. 7, a total of four pins 200 can be used to operatively connect two rods 190 to the rest of the apparatus 130. As shown, the upper projection 202 of each pin 200 can be received within the opening 198 in the blocks 196 provided at each end of the connection rods 190. The upper projection 202 may simply reside inside of the opening 198. Alternatively, the upper projection 202 can be secured in the opening 198 by, for example, threaded engagement, welding, adhesives, or interference fit, to name a few possibilities. Preferably, the connection rods 190 are removably secured to the pins 200. For instance, the connection rods 190 can be secured to the pins 200 using bolts (not shown). To that end, the upper projections 202 on the pins 200 can include internal threads for engaging the bolts. Likewise, the lower projections 204 of the pins can be secured to other components of the pivoting tool assembly 130 by bolts.

Turning to the two pins 200 at the proximal end 192 of the connection rods 190, the middle section 206 can be disposed within openings 208 provided in the handle 138. The middle sections 206 of the pins 200 can simply reside in the openings 208, or additional securement devices can be employed including threaded engagement, adhesives, welding, press fit. The lower projections 204 of the pins 200 at the proximal end 134 of the shaft 132 can be substantially disposed within grooves 210, which can be generally arcuate in conformation, provided in the upper mount 144. The grooves 210 can be sized to permit travel of the lower projections 204 within the grooves 210 in response to a user actuating the handle 138, as will be discussed later. The grooves 210 can be shaped to correspond to the travel path of the handle 138.

The distal ends 194 of the two connection rods 190 can be operatively connected to the pivot arm 162 by, for example, two pins 200. In such case, each middle section 206 of the pins 200 can be disposed within a respective groove 212 in the adapter 160. The grooves 212 can be generally arcuate in shape, and can be substantially identical to the grooves 210 in the upper mount 144. The lower projection 202 of the pins 200 at the proximal end 136 of the shaft 132 can be received in the openings 214 provided in the plate 170. The lower projections 202 can be secured in the openings 214 in various manners including those previously discussed. The lower projections 202 can also remain unattached or unsecured within the openings 214. The manner in which the connection rods 190, pins 200 and other components cooperate will be discussed below.

The pivoting tool apparatus 130 can include a tool head 180 having a working portion 182 and a connection portion 184. The previous discussion of the tool head 30 in connection with the embodiments shown in FIGS. 1-4—including the examples of the tool heads shown in FIG. 5, the various associated features and the manner of attachment to the pivot arm—applies equally to the embodiments of the invention shown in FIGS. 6-8.

When assembled, embodiments of the invention allow a user to quickly adjust the orientation of the tool head 180 so that such difficult areas can be more easily reached. One of the many ways in which embodiments of the invention can be used will be described with reference to FIGS. 6-8. The operation of the device will be described in the context of a pivoting tool 130 having a garden hoe for a tool head 180.

At the outset, the user may wish to use the hoe in the conventional manner; thus, the tool head 180 and pivot arm 162 can be substantially aligned with the shaft 132. In such case, the strip of spring steel 148 can be engaged with one of the notches 154 in the wall 152 on the handle 138. The user can use the hoe in a conventional manner by pulling the shaft 132 toward himself such that the hoe working head 182 scratches across the ground.

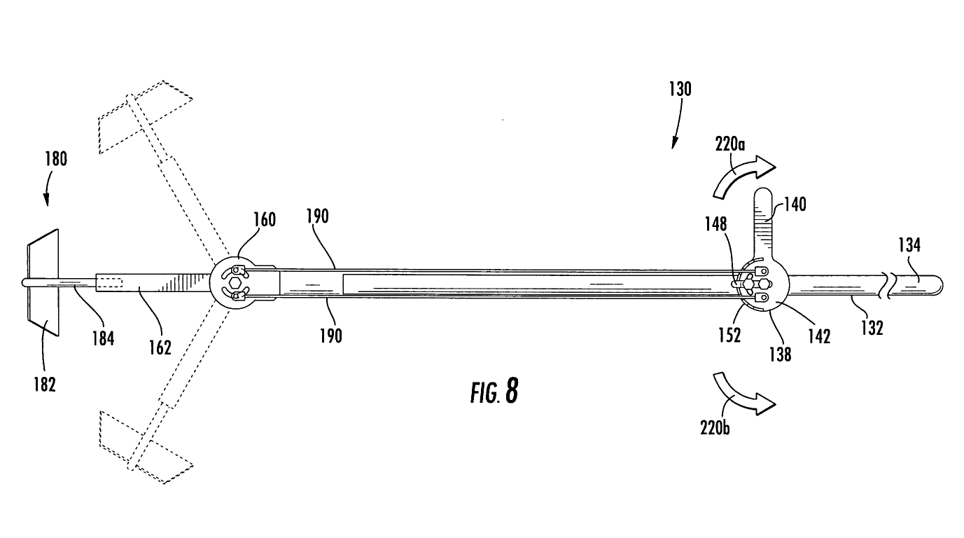

When the user comes into are area that is difficult to access, the angular orientation of the tool head 180 and pivot arm 162 relative to the shaft 132 can be adjusted, as shown in FIG. 8. In such case, the user can lift upwardly on the strip 148 such that the strip 148 disengages the notch 154 in which it was disposed as well as all of the other notches 154 in the wall 152. Now the user can grab the actuator portion 140 of the handle 138, and move the handle 138 clockwise 220a or counterclockwise 220b relative to the shaft 132, depending on the desired orientation of the pivot arm 162.

When the user moves the handle 132, in one pivoting direction or the other, the pins 200 associated with the handle 138 move as well. For instance, in FIG. 8, the handle 138 can be moved in the clockwise direction 220a. Because the middle section 206 of the pins are connected to the openings 208 in the handle 138 and because the lower projections 204 of the pins 200 are free to move within groove 210, the pins 200 will travel along with the handle 138. In addition, the blocks 196 at the proximal end 192 of the connection rods 190 are connected to the upper projection 202 of the pins 200; therefore, the connection rods 190 will necessarily follow as well with one of the rods 190 being pulled toward the proximal end 134 of the shaft 132 and one of the rods 190 being pushed away from the proximal end 134 of the shaft 132.

The motion of the handle 138 is transmitted along the length of the rods 190 to the pivot arm 162. Again, the connection rods 190 can move in opposite directions to each other, while each connection rod 190 can remain substantially parallel to the shaft 132 or its longitudinal axis. Because the blocks 196 at the distal end 194 of the connection rods 190 are connected to the upper projection 202 of pins 200, the pins 200 will move in opposite directions as well. The middle section 206 of the pins 200 will move along the grooves 212 provided in the adapter 160. On the other hand, the lower projections 204 of the pins 200 reside within the openings 214 in the plate 170, which, in turn, is secured to the pivot arm 162. The pivot arm 162 is pivotally mounted to the adapter 160. Thus, as one pin 200 moves away from the proximal end 134 of the shaft 132, and one pin 200 moves toward the proximal end 134 of the shaft 132, the pivot arm 162 will pivot to the side being pulled toward the proximal end 134 of the shaft 132. As shown in FIG. 8, if a user turns the handle 138 clockwise 220a, then the pivot arm 162 and attached tool head 180 will pivot clockwise. Similarly, if a user turns the handle 138 counterclockwise 220b, then the pivot arm 162 will pivot counterclockwise as well.

Once in the desired position, the user can release the strip of spring steel 148. Out of its own resiliency, the strip 148 can move into engagement with one of the plurality of recesses or notches 154 in the wall 152, which can include one or more features, such as a chamfer, to facilitate engagement. Then, the user can use the pivoting tool 130 to reach those challenging areas or to accomplish the job without undue strain.

It should be noted that a recess 154 may or may not be provided at that exact location desired and the user may have to move the pivot arm 162 to a position where the strip 148 can engage a recess 154. Any number of recesses 154 can be provided, and the range of lock positions of the apparatus 130 will be determined by at least by the quantity and placement of the recesses 154 associated with the handle 138. In one embodiment, there can be at least three recesses. One of the plurality of recesses 154 can be positioned such that, when the strip 148 engages this recess, the pivot arm 162 and the shaft 132 are substantially aligned, as shown in FIG. 6, which, to facilitate discussion, will be referred to as the central position or central recess.

Additional recesses can be positioned such that, when the strip 148 engages these recesses, the pivot arm 162 can be oriented at about 90 degrees relative to the shaft 132 or to the longitudinal axis of the shaft 132. Preferably, there are two of such recesses positioned such that the pivot arm 162 can be substantially locked at about 90 degrees relative to the shaft 132 on either side of the central position, thereby permitting a range of about 180 degrees of lock positions. Alternatively or in addition, two recesses or notches can be provided at substantially 45 degrees in either direction of the central notch, thereby permitting a range of at least about 90 degrees of lock positions.

The range of motion of the apparatus 130 need not be substantially equal on either side of the central position. For instance, the pivot arm 162 may be able to pivot substantially 90 degrees to one side of the central position and only substantially 45 degrees in the opposite direction with respect to the central position. The wall 152 on the handle 138 can have even more notches or recesses positioned so as to orient the pivot arm 162 at about 30 and/or at about 60 degrees relative to the shaft 132 or the longitudinal axis of the shaft 132.

Again, any quantity of recesses or notches 154 can be provided. Further, the notches 154 can be spaced according to regular intervals, such as about every 10 degrees. Alternatively, the notches 154 may be provided at irregular intervals or according to no particular pattern. Notches 154 may be provided at unequal intervals on either side of the central notch. Moreover, there need not be an equal number of notches 154 on each side of the central notch or on either side of the longitudinal axis of the shaft 132.

Yet another determinant of the range of motion of the pivoting tool 130 according to the invention in the configuration of the grooves 210 provided in the upper mount 144 and/or the grooves 212 provided in the adapter 160. Ideally, the grooves 210 and the grooves are substantially identical. However, the two grooves 210 provided on the upper mount 144 can but need not be identical to each other. Similarly, the two grooves 212 provided on the adapter 160 can but need not be identical to each other.

It will of course be understood that the invention is not limited to the specific details described herein, which are given by way of example only, and that various modifications and alterations are possible within the scope of the invention as defined in the following claims.

1. A pivoting tool comprising:
an elongated shaft having a proximal end, a distal end, and a longitudinal axis defined therebetween;
a pivot arm having a first end including a plurality of notches therein and a second end adapted for connection to a tool head, the pivot arm being pivotally connected at its first end to the distal end of the shaft; and
a lock pin movably connected to the distal end of the shaft, the lock pin being movable between a first position and a second position,
wherein, in the first position, the lock pin substantially lockingly engages one of the plurality of notches in the first end of the pivot arm, whereby the pivot arm is prevented from pivoting relative to the longitudinal axis of the shaft,
wherein, in the second position, the lock pin is substantially disengaged from the plurality of notches in the pivot arm, whereby a user can pivotally adjust the orientation of the pivot arm relative to the longitudinal axis of the shaft.

2. The pivoting tool of claim 1 further comprising a tool head secured to the first end of the pivot arm.

3. The pivoting tool of claim 2 wherein the tool head is a gardening tool.

4. The pivoting tool of claim 2 wherein the tool head is one of scrub brushes, brooms, mops, and squeegees.

5. The pivoting tool of claim 1 wherein the lock pin is biased toward the first position.

6. The pivoting tool of claim 5 wherein the lock pin is biased toward the first position by a spring.

7. The pivoting tool of claim 1 wherein the lock pin is disposed at least partially within the distal end of the handle.

8. The pivoting tool of claim 1 wherein the lock pin moves substantially along the longitudinal axis of the shaft.

9. The pivoting tool of claim 1 further including a trigger extending from the lock pin, whereby a user can engage the trigger with a finger to move the lock pin between the first and second positions.

10. The pivoting tool of claim 1 wherein the pivot arm has a range of pivoting motion of about 90 degrees on each side of the longitudinal axis of the shaft.

11. The pivoting tool of claim 1 wherein one of the plurality of notches is positioned on the pivot arm such that, when the lock pin substantially lockingly engages the one of the plurality of notches, the pivot arm is substantially in line with the shaft

12. The pivoting tool of claim 1 wherein one of the plurality of notches is positioned on the pivot arm such that, when the one of the plurality of notches is substantially lockingly engaged by the lock pin, the pivot arm is disposed at one of about 90 degrees, about 60 degrees, about 45 degrees, or about 30 degrees, with respect to the shaft.

13. A pivoting tool comprising:
an elongated shaft having a proximal end and a distal end and a longitudinal axis extending therebetween;
a pivot arm having a first end and a second end, the second end of the pivot arm being adapted for connection to a tool head, the first end of the pivot arm being pivotally connected to the distal end of the shaft;
a handle movably mounted to the shaft; and
a pair of connecting rods, each connecting rod having a proximal end and a distal end, wherein the proximal ends of the connecting rods are operatively associated with the handle, wherein the distal ends of the connecting rods are operatively associated with the pivot arm;
wherein movement of the handle is transmitted to the pivot arm by the connecting rods such that the pivot arm pivots in substantially the same direction as the movement of the handle.

14. The pivoting tool of claim 13 wherein the connecting rods are substantially parallel to the longitudinal axis of the shaft

15. The pivoting tool of claim 13 further including a tool head secured to the first end of the pivot arm.

16. The pivoting tool of claim 15 wherein the tool head is a gardening tool.

17. The pivoting tool of claim 15 wherein the tool head is one of scrub brushes, brooms, mops, and squeegees.

18. The pivoting tool of claim 13 further comprising a lock for substantially maintaining the pivot arm in place relative to the shaft.

19. The pivoting tool of claim 18 wherein the handle includes a raised wall along a portion of the handle, the raised wall includes a plurality of notches, where the lock comprises a strip of spring steel that substantially lockingly engages one of the plurality of notches in the raised wall.

20. The pivoting tool of claim 19 wherein one of the plurality of notches is positioned on the raised wall such that, when the one of the plurality of notches is substantially lockingly engaged by the strip of steel, the pivot arm is disposed at one of about 90 degrees, about 60 degrees, about 45 degrees, or about 30 degrees, or substantially in line with respect to the shaft.
